(19) United States
(12) Patent Application Publication
(10) Pub. No.: US 2005/0182676 A1
(43) Pub. Date: Aug. 18, 2005

(54) Method and system for advertisement campaign optimization

(76) Inventor: Brian Ka Kui Chan, Richmond Hill (CA)

Correspondence Address: Brian Ka Kui Chan, 76 Hillhurst Drive, Richmond Hill, ON, L4B 3C4, CA

(21) Appl. No.: 10/779,003

(22) Filed: Feb. 17, 2004

(51) Int. Cl. G06F 17/60

(52) U.S. Cl. 705/14

(57) ABSTRACT

A system and method is disclosed for optimizing advertisement campaigns in consideration data including information not relating to the advertisement campaigns according to the advertisement network server. A campaign optimization unit optimizes advertisement campaign in consideration of data retrieve from data servers including local advertisement network server and external data servers that physically located away from the advertisement network server. Information collectors are used to obtain, collect, and validate data from local ad network server, and data from various sources via network. The system will consider any authorized information in order to maximize the effectiveness of automatic campaign optimization.

### CROSS-REFERENCE TO RELATED APPLICATIONS

Not Applicable

### REDERALLY SPONSORED RESEARCH

Not Applicable

### SEQUENCE LISTING OR PROGRAM Not Applicable

### BACKGROUND OF THE INVENTION

1. Field of Invention

The present invention relates generally to online advertisement campaign optimization system and method.

2. Discussion of Prior Art

The attraction of the Internet media to the general population is causing a significant shift in the traditional channels of advertisement. And advertising has been a big topic in the Internet industry. Many advertisement networks and technologies have been developed and invented.

Advertisement network (“ad network”) serves as a medium between advertisers and publishers. Advertisers create a campaign on the advertisement network, categorizing the target audiences. Many methods and systems relate to advertisement selection have been invented, systems such as U.S. Pat. No. 5,948,061, titled “Method of delivery, targeting, and measuring advertising over networks” to Merriman, Sep. 7, 1999, U.S. Pat. No. 5,948,061, “Method of delivery, targeting, and measuring advertising over networks” to Merriman, et al., Sep. 7, 1999, and U.S. Pat. No. 6,026,368, “On-line interactive system and method for providing content and advertising information to a targeted set of viewers” to Brown, et al., Feb. 15, 2000. All these inventions relate to “advertisement selection” method, which is used to select the best and most suitable advertisements to delivery to the viewers.

However, the best way of select an ad is not the only important component in the success of a company's advertising plan. What happens if one company's ad is always the best ad to be selected or viewed? The ways of how a company distribute its resources according to different market situation, product trend, timing, inventory is also a very important component of in efficient marketing and advertising planning.

Generally, an efficient advertisement delivery network comprises of two major components, advertisement selection and campaign optimization. Advertisement selection is about selecting the most suitable advertisement to a user, bringing attentions of user and further attract potential business opportunities for advertisers. In general, advertisement selection focuses on user characteristics.

Another major component of an efficient advertisement delivery network is having efficient and flexible campaign optimizations, which is an object of the present invention. Campaign optimization generally focuses on advertiser, rather than user; Campaign optimization is used to allocate advertiser resources according to different factors, including but not limited to: number of impressions, rate of click through. In addition, campaign optimization relates more to marketing planning of advertisers.

An example is given now to show the principles of advertisement selection and campaign optimization:

Advertiser ABC wants to promote a new product to the general public, therefore, he creates an advertisement campaign of the new product on an advertisement network server. According to his marketing plan, he wants to have conditional multiple waves of promotions as follow: If the number of the product sold in the past month is below 1 million, the advertiser wants to set the campaign budget (campaign resource allocation) to $100K for the first week of next month. After the first week of next month, decrease the campaign budget to $10K until the end of next month. However, if the number of the product sold in the past month is over 1 million, the advertiser wants to set the campaign budget of the next whole month to $30K (campaign resource allocation). The budget adjustment process is run on the first day of each month for a continuation for 5 months. The conditions described above are closely related to advertiser's interests and resources allocation, this is one type of campaign optimization.

Continuing with the example, when a publisher wants to delivery an advertisement to an user, the advertisement network then perform advertisement selection. There are few things that may be used in the ad network in this example. The advertiser may consider which ads are available to choose, and then choose the best ad according to the category of the publisher or user. In the example, if the publishers is requesting the advertisement in the first week of a month after a month of sales over 1 million pieces, then there may be a high chance that the ad of advertiser ABC will be chosen, it is because of the campaign resources is telling the advertisement selection process a message that “we have lots of resources for this ad, deliver me”. However, if the request is made at the end of a month after a bad month to advertiser ABC, then the chance of the ad being chosen is slim. It is because the campaign resources (set by campaign optimization process) is telling the advertisement selection process a message “we do not really have much resources for this ad, you may want to choose another ad with more resources”. In the example, we can see that advertisement selection and campaign optimization are closely related and both are very important to an advertisement delivery network.

Therefore, ad campaign management and optimization has been done on advertisement campaigns to provide better results. Ad campaign optimization can help advertisers to control their marketing spending more efficient. For example, a company has two ad campaigns running in parallel on the World Wide Web, and they are two different banner ads about different products. If one of the ad campaign's spending (always selected to be run, belongs to a large category etc.) is running high while the other one is low, the advertisers may want to restrict the resources of the running high one. This is another type of campaign optimization.

Limiting the spending per month, per day is another ways of ad campaign optimization. Advertisers optimize their ad campaigns in order to maximize their return of their marketing investment. Some optimization methods 105 including analyzing the statistics of ad campaigns; then change the weights of impression, amount of future spending according to different standards and criteria. Generally, ad network provides statistics of ad campaigns and perform analysis on these data. Advices are generated depends on the optimization criteria and factors.

Currently, many optimization methods 105 are provided by ad networks such as FastClick Inc.'s online advertising system, DoubleClick Inc's DART product. However, these products only optimize campaign based on information provided by advertisers manually or generated through statistics of ad campaign system. None of them use the strength of the internet and obtain data from external sources outside the ad network in order to maximize the automation of ad campaign optimization.

There are two known prior arts related to online marketing that use external sources. It has been known in the prior art that data can be import data in metadata format from external sources as disclosed in the user manual of DoubleClick Inc.'s latest version Ensemble Campaign Manager. However, this product is configured as an in-house product but not in a hosted advertisement network configuration. Moreover, the Ensemble Campaign Manager is not using the metadata directly to automate the optimization process.

It has also been know in the prior art that advertisement can be optimized to a particular user or group of users for a current transaction as disclosed in U.S. patent application No. 20030088463, entitled “SYSTEM AND METHOD FOR GROUP ADVERTISEMENT OPTIMIZATION” to Kanevsky, Dimitri et al., filed on Oct. 21, 1999. In the application, it discloses an invention for generating an advertisement that is optimized for one or more persons located at a public location using personal data from various sources (including external sources). However, the invention is actually an advertisement selection method that belongs to the “advertisement selection” category discussed earlier, which does not provide campaign optimization function. It is a way of selecting which ads to display from a plurality of ads, not campaign optimization. For example, if there is two ads available for the ad server to select, if ad A is always the one chosen to display and ad B is not chosen at all, the invention can do nothing to improve the performance of ad B. It is because it is an advertisement selection method, not an optimization method 105. A good optimization method 105 can help the advertiser of ad B to improve the allocation of resources or even provide good advices, after a good optimization (increase ad rate, change ad material etc), ad B may increase its chance to be chosen.

Here are a few scenarios that the no prior art can solve. Scenario 1, a company wants to have a sales campaign on certain items which are overstocked (high inventory level). In this case, the company can create short term advertisement campaigns for each item to promote them to the general public on the internet. The advertiser provides the campaign with a large amount of campaign resources (high ad rate or large impression volume) at the time of campaign creation. As the success of the sales campaign (stocked item volume decreases), the company may wants to decrease the campaign resources (ad rate or impressions available) in its advertisement campaign according to the stock level in order to decrease the rate that the ads are loaded. In this case, the determining factor would be the number of stock of each item in the company's inventory. In this case, no prior art is able to help the advertisers to decrease the resources, in accordance to the functions of prior art, the best an advertiser can do is to log on to the ad server and adjust the resources manually.

Another scenario is that a ski equipment retail company creates a campaign to advertise its winter equipment. However, he only wants to advertise when it is in snow season, this means that he only wants to make his campaign resources available (that means the ad is made possible to be selected) to selected audience when snow is going to fall within the next two week in certain areas. In this case, the determining factor is the snow forecast of the next two weeks in certain areas. Therefore, no matter how good an optimization method 105 is, it is impossible to forecast the weather without obtaining data from external resource. The best the company owner can do is to check the weather forecast every day, and log on to the ad server and give its campaign certain campaign resources manually.

Scenario 3, an auction company have created 20 campaigns for the top 20 bided categories. The company always want to put half of the advertising spending or resources on the category with the most items opened for biddings. With prior arts, related personnel of the auction company have to check the auction listings everyday or every hours, find out which one of the 20 categories have the most item listed. And then log on the ad network server and adjust the resources manually.

Thus, there is no prior art that provides automatic advertisement campaign management and optimization in an advertisement network setting using non-marketing-related information from external sources. Since it is obvious that a company advertises only when it thinks advertising and marketing can fit into their business or marketing plans. And the business or marketing data are basically the driving forces of advertisement or commercials. Therefore, to have the most efficiency, flexibility, more direct advertisement campaign, we need to start from the sources of the decisions (marketing plan, business plan, and business operation information etc.).

### OBJECTS AND ADVANTAGES

An object of the present invention is to improving the efficiency, flexible and intelligence of advertisement campaign optimization.

Another object of the present invention is to provide a system and method for automating advertisement campaign management and optimization in an advertisement network environment using information from external sources.

Another object of the present invention is to provide a system and method for automating advertisement campaign management and optimization in an advertisement network environment using non-advertisement-campaign related information according to the advertisement network.

Another object of the present invention is to provide a system and method for controlling advertisement resources from the sources of advertising decisions intelligently.

Another object of the present invention is to provide a system and method for ease of adaptation on to different advertisement selection methods, and without losing flexibility.

Another object of the present invention is to provide a system and method for adapting different types of optimization methods 105 and software architecture.

Another object of the present invention is to provide a system and method for accessing different type of external data.

Another object of the present invention is to provide a system and method to validate external data and further ensuring data qualification.

Another object of the present invention is to provide a system and method for automatic and manually campaign optimization.

Another object of the present invention is to provide a system and method for building an efficient and intelligent in house ad system.

Yet another object of the present invention is to provide a system and method for adapting campaign optimization in an environment that advertising via a communication network to public visual and audio devices.

Still another object of the present invention is to provide a system and method for improving the efficiency of most advertisement selection method. Since the present invention optimizes campaign resources, which are major advertisement selection factors. It is known that better optimized campaign equal more information, more information improves advertisement selection results.

The overall system architecture according to the present invention allows distributed advertisement delivery. All components can either be at a single centralized location or on different machines and in different places.

In accordance with these objects, the campaign optimization method 105 can solve the problems that no prior art can solve. Referring back to the three sample scenarios discussed above:

In the overstocked company scenario, the present invention provides a system and method that allows the ad network server to obtain inventory related information from the company's in house system before the optimization and allows the optimizer to consider the information during optimization. The ad network may use a FTP client to download a XML file with inventory information from the company's XML database and retrieve data from it. Therefore, the optimizer can consider the inventory level, if the inventory level is low, limit the campaign resources. The lower the inventory level goes, the further the limitation becomes.

In the ski equipment company scenario, the present invention allows an ad network to retrieve weather forecast for next two weeks for certain areas before performing optimization. The ad network server may be invoking a web services using HTTP protocol. During the optimization, the optimizer gets the updated weather forecast information. If the areas will be snowing next week, the optimizer can optimize the campaign and assign suitable resources.

In this case, the ad can start be showing without notifying the company, but at the same time it is performing the desire results.

In the last scenario of the auction company, the ad network may access open a connection to the auction database and use a SQL statement to query which one of the twenty categories are having the most item listed. After obtaining the data, the optimizer can run and perform the desire resource allocation.

Further objects and advantages of my invention will become apparent from a consideration of the drawings and ensuing description.

### SUMMARY OF INVENTION

The system and method of the present invention provides for optimizing advertisement campaign data using both campaign-related and non-campaign-related data according to an advertisement network server. The present invention provides a method that allows campaign optimizers to retrieve statistics and information from internal resources as well as data from external data sources. With the extended data accessing ability, advertisers can integrate their business and marketing plan directly into their campaign management strategy to save cost, increase efficiency and flexibility.

### BRIEF DESCRIPTION OF THE DRAWINGS

FIG. 1 shows the network architecture of the present invention

FIG. 2 shows the system architecture of ad network server

FIG. 3 shows an exemplary optimization method 105 database

FIG. 4 illustrates a functional block diagram depicting the various functional and processing units performed by optimization unit

FIG. 5 illustrates the steps that are performed by optimization unit in a flowchart

FIG. 6 illustrates the processes of second information collector (external) in a flowchart

### DETAILED DESCRIPTION OF THE PREFERRED EMBODIMENT

A detailed description of an exemplary and preferred embodiment of the present invention will now be described with reference to figures. Although this description provides detailed examples of possible implementations of the present invention, it should be noted that these details are intended to be exemplary and in no way delimit the scope of the invention. A person skilled in the relevant art will recognize that other components and configurations may be used without parting from the spirit and scope of the invention.

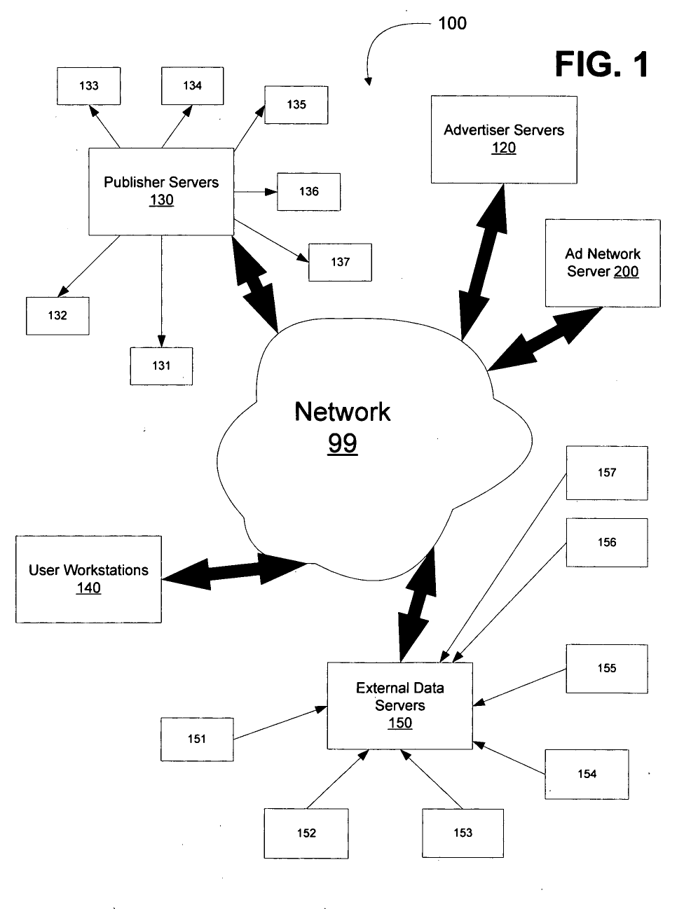

The present invention comprises of a system and a method. The preferred embodiment of the present invention is shown in an online advertisement delivery network configuration. The advertisement network system of the present invention is shown in FIG. 1. As shown in FIG. 1, the advertisement delivery network 100 configuration includes an ad network server 200, a plurality of advertiser servers 120, a plurality of publisher servers 130, external Data Servers 150, and a plurality of user workstations 140 where communication can be sent electronically via a network 99. It is understood that the network 99 includes the Internet.

Generally, a publisher server 130 is an entity that permits third party advertisements to be displayed via advertisement terminals. In general, publisher servers 130 refer to various advertisement terminals that are equipped with various types of media communication devices including one or more, but not limited to: web sites banner space 131, electronic billboard displays 132, television and monitors or digital display devices 133, loud speaker systems 134, large screen displays 135, projection and movie screens 136, printers 137, or any display media where advertisements can be sent electronically via network 99. The exemplary preferred description of the present invention use a web page ad banner setting that is very common in advertisement networks. That is, a publisher is a web site that allows third party advertisements to be displayed via its web site in the description.

When user workstation 140, through a web-browser interface, downloads a web page from publisher server 130, an advertisement provided by the ad network server 200 is overlaid onto the display of the publisher's web page. It should be noted that the advertisement can be provided directly by ad network server 200 or can be provided by another ad server (not shown) that receives an ad request that has been redirected by ad network server 200. If publisher is a non browse-able terminal (electronic billboard displays, television and monitors or digital display devices, or loud speaker systems, large screen displays, projection and movie screens etc), user workstation 140 may not exists.

In the following description, the term advertiser server is used to refer to any source of advertising content, whether or not that source of advertising content was the original recipient of an advertising content request. After the ad is displayed on a reserved portion of the publisher's web page, the user can connect to advertiser server 120 by clicking through or otherwise selecting the advertisement (e.g., image, icon, etc.). The user may not be able to connect to advertiser server 120 if the advertisements are not selectable (public video display etc).

In preferred embodiment, the operation of advertisement delivery network 100 begins when user workstation 140 contacts publisher server 130 by generating a hypertext transfer protocol (HTTP) message to get the information for the desired web page. Publisher server 130 then responds by transmitting web page information, such as a compilation of hypertext markup language (HTML) code, JavaScript, Java applets, graphic image files (e.g., GIF, JPEG), etc., that is used by user workstation 140 in rendering the requested web page in the user's web browser interface.

As part of this compilation of web page information, publisher server 130 also sends a tag (e.g., applet tag) that identifies the source of the ad. Using the received tag, user workstation 140 can then send a message to ad network server 200 to request the ad to be inserted into the web page. As noted above, this request may be redirected to yet another third party ad server. As part of this ad request, user workstation 140 can also send information, such as information that identifies the web site, location in the web site, location in the web page where the advertisement is to be displayed, user identification, etc., that ad network server 200 can use to determine which ad to send to user workstation 140.

Upon receiving the request by user workstation 140, ad network server 200 determines which advertisement to provide to user workstation 140. Once identified, the advertisement is transmitted to user workstation 140 and overlaid onto the web page that is been rendered by user workstation 140 in the web browser interface.

There are many methods and mechanisms that can be used by ad network server 200 to determine which ad to send to user workstation 140. For example, the ad server network 200 can select an ad that has the most impression inventory available, the ad network server sends the ad with the most impression available.

Another commonly used advertisement selection method the ad network server may use is to select an ad that is associated with the highest advertisement rate. Advertisement rate is the price that the associated owner of the ad willing to pay for. For example, if the advertiser has a CPM (cost per 1000 view/impression) campaign, and the advertisement rate of it is $7.00. That means the advertiser has to pay spend $7.00 after its ads has been showed or loaded for a 1000 times. Another selection method relates to a CPC (Cost per Click) campaign. If the advertisement rate is $0.35, it means that the advertiser has to pay 35 cents every time a user click on its ad. In general, advertisement selection method varies in large range between different types of campaigns, methods and technologies. Different types of advertisement selection method can be used.

The ad is not limited to any format, size, or presentation. The ad can be an image file, a java program, a simple hypertext link, a video, an audio, or a flash file etc. that can be displayed via electronic terminals.

External Data Servers 150 include any external data sources that provides part or all of the second information 102 to the ad network server 200. External Data Server 150 may be one or more of the following system: web services 151 provided by other parties, text files 152 located somewhere externally to ad network server, email servers 153, FTP servers 154, databases 155 not residing within ad network server, voice mail servers 156, or SMS servers 157. The advertiser network server 120 may be also the external data server 150. Publisher server may be also one of the external data servers 150. External Data servers 150 generally are data sources that are located physically away from the ad network server 200, but are communicable with ad network server 200 via network 99. External data servers 150 provide data to ad network server 200 as requested, send data to ad network server 200 periodically. The ad network server 200 then uses the received data to perform campaign optimization. Data from external data servers 150 may include data relating to advertisement campaigns, and data not relating to advertisement campaigns (data relating to general business operation of the advertiser server etc.).

The ad network server 200 can be also part of the advertiser server 120, or the publisher server 130. In one embodiment, ad network server 200 can be configured as part of advertiser server 120.

Network 99 may be a wired network, wireless network, or both. In the wireless environment, the publisher server 130 may be a wireless video billboard, a WAP page. The user workstation 140 maybe a cell phone, a laptop with wireless connection, a PDA, a wireless electronic touch screen billboard, or any other wireless networking capable devices.

Using the above components, the present invention provides a system to allow advertisers to optimize their ad campaign on an advertisement delivery network automatically with data from various sources.

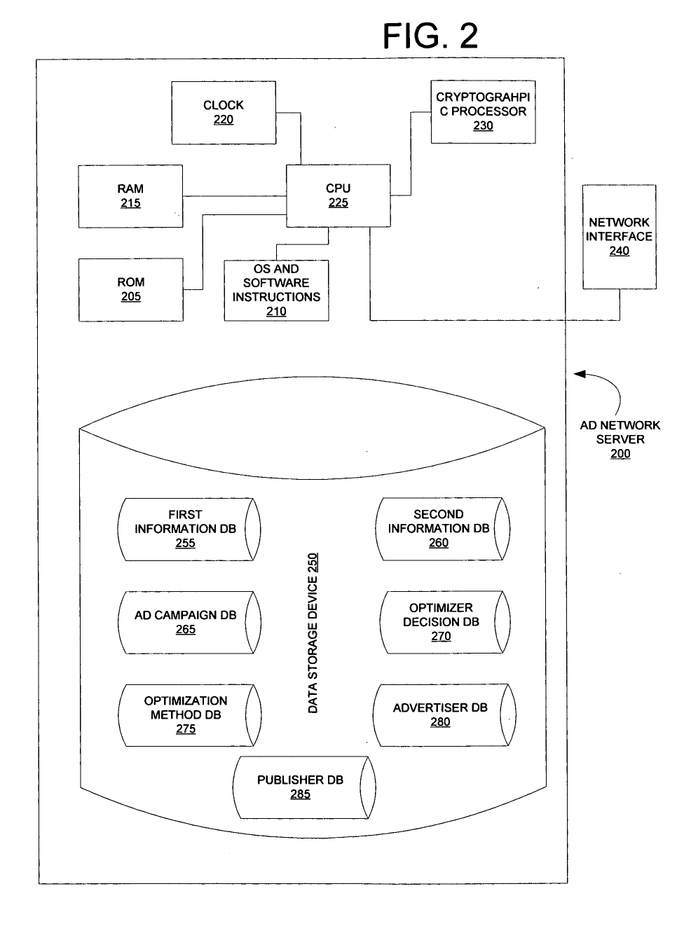

As shown in FIG. 2, the ad network server 200 includes ROM 205, Operating System and software instructions 210, RAM 215, clock 220, central processor (CPU) 225, cryptographic processor 230, network interface 240, and data storage system 250.

A conventional personal computer or computer workstation with sufficient memory and processing capability may be used as ad network server 200. The ad network server 200 must be able to handle high volume of transaction and large amount of mathematical calculations for communication and data processing. The ad network server 200 may be configured as a web server. The RAM 215 and ROM 205 are used to support the program codes that operated by the processors 225 in the present invention. The memory may be in a form of a hard disk, CD ROM, or equivalent storage medium.

A Pentium 4 2.4 GHz microprocessor, manufactured by Intel Inc., can be used for the CPU 225. An MC68HC16 microcontroller, commonly manufactured by Motorola Inc., or any equivalent may be used for cryptographic processor 230. Cryptographic processor 230 supports the authentications such as communications from external Data Servers 150 and ad network server 200, as well as allowing for anonymous transactions and general data encryption. Cryptographic processor 230 may be configured as part of CPU 225. Other commercially available specialized cryptographic processors include Semaphore Communications' 40 MHz Roadrunner284.

In the preferred embodiment, data storage system 250 may include hard disk magnetic or optical storage units, as well as CD ROM, CD RW or DVD Rom and flash memory such as Compact flash and secure digital cards. Data storage system 250 contains databases used in the processing of transactions in the present invention including first information DB 255, second information DB 260, Ad campaign DB 265, optimizer decision DB 270, optimization method DB 275, advertiser DB 280, and publisher DB 285. In the preferred embodiment, database software such as Oracle 9i, manufactured by Oracle Corporation, is used to create and manage these databases.

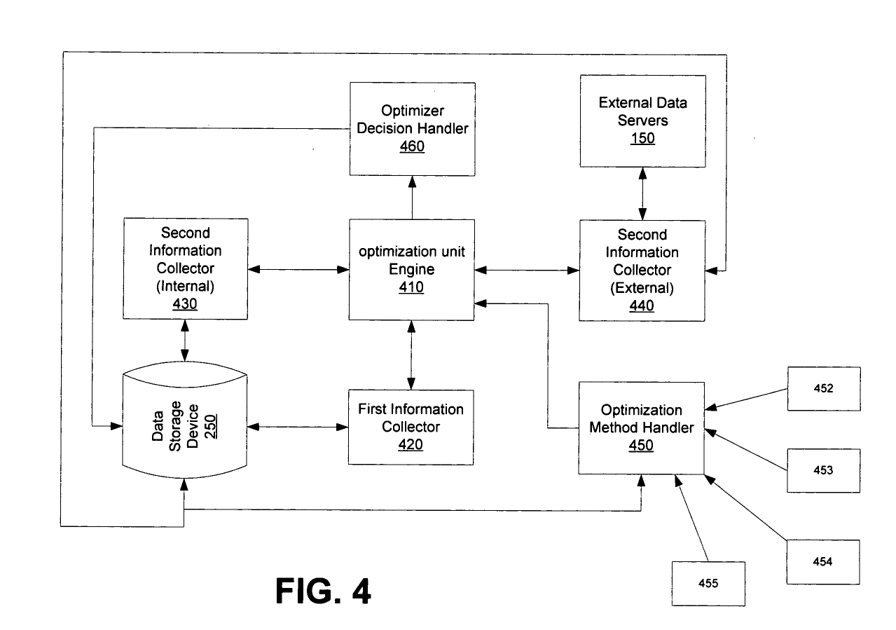

First information DB 255 tracks all information pertaining to the campaign optimization method 105 an advertiser has chosen. First information DB 255 may be used as a summary database by an optimization unit 103 to retrieve and store first information 101. In preferred embodiment, first information includes all static information that can be retrieved locally within ad server network 200. The optimization unit 103 is a functional unit of present invention that performs the ad campaign optimization, detailed description of optimization unit 103 will be provided in FIG. 4.

In one embodiment, first information DB 255 is removed; optimization unit retrieves first information 101 directly from original sources within ad network server 200. Those skilled in the art will realize that first information DB 255 can also be distributed over a plurality of different databases depends on different configurations.

Second information DB 260 tracks all second information 102 that is needed by optimization unit 103 at the time it is triggered. In the preferred embodiment, second information 102 includes two groups of data, first group 105 and second group 106. The first group 105 of information 102 includes all dynamic data that is available and retrievable within ad network server 200. The second group 106 of information 102 is any data that needs to be retrieved from external sources via network 99. The grouping, categorization describe herein is only an exemplary approach out of many different possible embodiments.

In the preferred embodiment, second information DB 260 is used as a temporary database that stores data that is retrieve from different channels or external server. Optimization unit 103 places all retrieved information into second information 102 DB until all required information are available.

For example, optimization unit 103 needs data A from source A, and data B from source B to perform an optimization. After the optimization unit 103 retrieves data B, optimization unit 103 puts the data in DB 260, and wait for data A to arrive. When data A arrive and stored in DB 260, the optimization unit starts the optimization using data from DB 260 and DB 255). After optimization is completed, optimization unit 103 removes data A and B from the DB 260, it is because they may be dynamic data and there is no reason to keep them within system 250. In general, second information DB 260 stores only temporary data before they are not useful to the optimization unit 103. A more detailed description relates to optimization unit 103 will be discussed in later sections. Those skilled in the art will realize that Second information DB 260 can also be distributed over a plurality of different databases depends on the optimization method 105 that is associated with different ad campaign. In one embodiment, Second information DB 260 is removed, and temporary data are stored in memory such as ROM 205, and cache etc.

Ad campaign DB 265 tracks all information pertaining to advertisement campaigns that are created by advertisers. Ad campaign DB preferably includes fields such as ad campaign ID, advertiser ID, Optimization method 105 ID, budget available, target audience demographic info, ad category, campaign start date, campaign end date, campaign type, ad language, maximum spending pre month, maximum spending pre week, maximum spending pre day, maximum spending pre hour, maximum spending pre publisher, maximum spending for the campaign, and campaign name etc. The data stored in the ad campaign DB 265 are used to describe an ad campaign created by advertisers. Some of the data stored in ad campaign DB 265 may overlapped with first information DB 255 depends on the optimization method 105 a campaign is configured with. Those skilled in the art will realize that optimization method DB 275 can be distributed over a plurality of different databases. In one embodiment, optimization method DB 275 is located externally to ad network server 200.

Ad campaign DB 265 also stores dynamic information related to the statistics and performance of an ad campaign, this optional fields include number of impression shown, number of click through, click through rate, impression available (the number of times that the advertiser wants the ad to be viewed/loaded in the future). This information tends to change frequently (dynamic); therefore, if they are needed by the optimization unit 103 for optimizations, they belong to the group second information 102, rather than first information 101.

Optimization decision DB 270 tracks all optimizer decisions 104 that are output or generated by the optimization unit 103. Fields in the Optimization decision DB 270 includes ad campaign ID, decisions in various forms. Exemplary decisions such as (ad campaign ID=“12513”, decision=“Impression next week=10 millions”, “publisher 2352 not allowed to deliver this ad”), (ad campaign ID=“2352”, decision=“CPC=$3.00”, “CPM=$0.20”), (ad campaign ID=“2345”, rate=“$0”, ad campaign ID=“2346”, rate=max rate). In general, optimization decision DB 270 stores outputs generated by optimization unit 103. The requirements and formats of decisions vary among chosen optimization methods 105. Optimization decision DB 270 maybe used as an error log for failed optimizations.

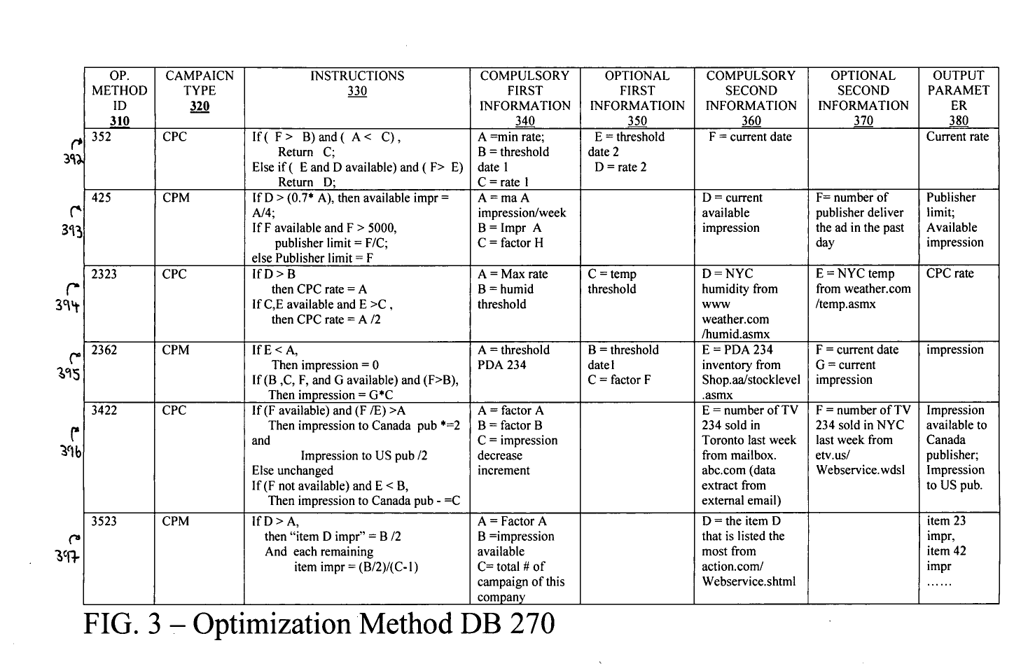

Optimization method DB 275 tracks all information pertaining to optimization methods 105 and includes data such as optimization method 105 ID, compulsory first information parameters, optional first information parameters, compulsory second information parameters, optional second information parameters, and optimization instructions in different forms. Those skilled in the art will realize that optimization method DB 275 can be distributed over a plurality of different databases. A detailed description and exemplary uses of DB 275 is described in FIG. 3.

Advertiser DB 280 tracks all information pertaining to the advertiser with fields such as advertiser ID, advertiser's name, advertiser contact information, advertiser category, number of advertisement campaign, and account credit information etc.

Publisher DB 285 tracks all information pertaining to the publishers with fields such as publisher ID, publisher's name, advertising location, physical address, phone, contact email, publisher group list, number of advertisement space, and types of advertisement support etc.

The data storage system 250 described above in no way delimit the scope of the database stored in the data storage system 250. It maybe made to include more databases, or integrated with other systems.

Network interface 240 is the gateway to communicate between servers 200, 120, 130, 140, and 150. Conventional internal or external modems may serve as network interface 240. A cable modem may be used as a network interface 240. Network interface 240 supports modem at a range of baud rate from 2400 upward. In the preferred embodiment, network interface 240 is connected to the internet. This allows publishers and advertisers access from a wide range of on-line connections. Several commercial electronic mail servers include the above functionality. Microsoft Exchange Server is a secure server-based electronic mail software package designed to link people and information over enterprise networks and the internet. Users can exchange messages with enclosures such as files, graphics, video and audio. Alternatively, network interface 240 may be configured as a voice mail interface, web site, BBS, electronic mail address, cellular, or mobile and wireless interface.

While the above embodiment describes a single computer acting as ad network server 200, those skilled in the art will realize that the functionality can be distributed over a plurality of computers. In one embodiment, ad network server 200 is configured in a distributed architecture, wherein the databases and processors are housed in separate units or locations. Some servers perform the primary processing functions and contain at a minimum RAM, ROM, and a general processor. Each of these servers is attached to a WAN hub which serves as the primary communication link with the other servers and interface devices. The WAN hub may have minimal processing capability itself, serving primarily as a communications router. Those skilled in the art will appreciate that an almost unlimited number of controllers may be supported. This arrangement yields a more dynamic and flexible system, less prone to catastrophic hardware failures affecting the entire system.

FIG. 3 illustrates an exemplary Optimization method DB 275 that preferably stores information used to describe each optimization method 105. It is also a mapping of data with optimization methods 105. DB 275 preferably includes information such as Optimization method ID 310, Campaign Type 320, Instructions 330, compulsory first information 340, optional first information 350, compulsory second information 360, optional second information 370, and output parameter 380. The optimization method DB maintains at least one record, such as records 392-397, each associated with an optimization method 105. Those skilled in art should realize that more data field can be used to describe an optimization method 105 and other use.

Campaign Type 320 describes the type of advertisement campaign an optimization method 105 belongs to. Exemplary value is “CPC” (Cost per click), “CPM” (cost per 1000 impression), others possible values are cost per lead, cost per action etc.

Instructions 330 are the main logics of the optimization methods 105. It is a series of logic or instructions that may accept compulsory first information 340, optional first information 350, compulsory second information 360, and optional second information 370 as parameters.

The next four fields 340-370 contains data relates to the optimization method 105 parameters. The four fields list all the required and optional parameters that may be useful in the generation an optimizer decision 104. The fields 340-370 contains information that is understood by optimization unit 103, the data within tells unit 103 what parameters may be useful to generate the optimizer decision 104. All the parameters from field 340-370 of a record union together are a superset of all useable optimization parameter for the optimization method 105 of the associated record. The four fields may be used as a data mapping table to map data to associated instructions and method, which is directly related to the optimization method 105. The data are categorized into four different fields in the preferred embodiment just for clarification purpose, the fields 340-370 can be combined together into one single field.

Compulsory first information 340 includes static information that can be retrieved within ad network server 200 and are compulsory to the associated optimization method 105. Therefore, if all the information listed in field 340 is not available to the optimization unit at the time of optimization, the optimization unit 103 fails the optimization and the optimizer decision 104 is an error message. The data requested in field 340 are static and unchanged until they are modified manually by the associated advertiser. For example, record 392 shows the assignation of variable to the instructions 330. In this record, it means that minimum rate, threshold date 1, and rate 1 are compulsory to this optimization method 105. If either one of the required data are not available or not qualified to be use from associated records in the first information DB record, then the optimization unit fails. Example of parameter in compulsory first information 101 would be an impression threshold of an ad campaign, a predetermined rate that an advertiser wants to set if it meets a condition. All these information can be set by advertisers and stay static until it is modified later in the preferred embodiment.

Field optional first information 350 is very similar to compulsory first information 340, however they are optional to the optimization instructions of the associated optimization method 105. This means that if any one or all the data that are listed in Optional first information 350 is missing; the optimization unit 103 can still generate a valid optimizer decision 104 if it is supplied with qualifying compulsory data. Referring again to record 392, it means that variable E and D are optional. However, it does not mean that the optimization method 105 must use E or D if they are available. In situations that it may need both E and D to be available in order for them to affect the optimizer decision. In the case of record 392, missing either E, D or both does not affect the result in the instruction. However, having only one of E or D available is not affecting the result either. The result may only be affected when both E and D are available.

A parameter listed in the optional first information 350 fields in one record can be listed as a parameter of a compulsory first information 360 in another record. For example, threshold date 1 is optional first information for record 395, but it is also a compulsory first information parameter for record 392. In which field a parameter is listed is dependent on the nature of the associated optimization method 105.

Compulsory second information 360 stores information that is related to the parameters needed by instruction 330. The parameters or data listed in field 360 is compulsory for a valid optimizer decision 104 to be generated. The only difference between fields 340-350 against fields 360-370 is that fields 360-370 contains only second information 102 that preferably belongs to one of two groups of data. For reference, the first group 105 of data is any dynamic data that is available within ad network server 200. the second group 106 of data is any data that needs to be retrieved from external sources. And among fields 360 and 370, field 360 refers to compulsory second information parameters of the associated optimization method 105 record, while field 370 contains optional second information parameters of the associated optimization method 105 record.

For example, current date, current temperature, number of impression an advertiser spent last week, number of time an ad is viewed or loaded, or the number of inventory that is in stock of a store. This kind of information cannot be set static or set fix by anyone, they tend to change dynamically. Referring again to record 392, the compulsory parameter for this optimization method 105 is the current date or the system date of clock 220, which belongs to the first group of second information.

Optional second information 370 works the same way as optional first information 350 to compulsory first information 340. An optional second information 102 parameter in one records can be a compulsory second information 340 parameter in another records, it is depending on the nature of the optimization method 105. Parameters listed in field 370 optional to the associated optimization method 105 that instruction 330 refers to.

In preferred embodiment, the fields 340-370 may maps data to any sources, including internal and external sources. Internal sources include data that are retrievable within the ad network server such as databases, system clock, memory status, and performance statistics. Data from internal sources may be either first information 101 or second information 102, but not both, depends on the nature of the data. If the internal source data is dynamic, then internal sources data is the first group 105 of second information 102. External sources include external data servers such as an external web services, an email server, a FTP server, a HTTP server. All data from external sources belong to second group 106 of second information 102. This function shows one major object of the present invention for using non marketing related information to optimize marketing resources allocation. Please note that the distribution and classification approach described above in no way delimit the scope of the invention. The approach described above is just one of many data classification methods that may be used in the present invention.

Output parameter 380 lists the output parameters of each associated optimization method 105. Referring again to record 392, the output parameter for this record is current rate. It means that after optimization unit 103 executes the optimization method 105 for this record, the current rate is the only thing that may be changed or modified. The parameters listed in field 380 shows what may possible be affected by the optimization after it is done. In general, field 380 tells optimization unit what to store in DB 275.

In order to have a better look on how data are classified in fields 330-380, we will look closer to exemplary records 392-397 in FIG. 3.

There are different types of optimization methods 105, referring to record 392, it shows a very basic optimization method 105. The optimization method 105 described in record 392 takes in compulsory first and second information to perform necessary optimization. It also takes optional parameters from optional first and second information 102.

An optimization method 105 described in record 393 shows a similar type of optimization method 105, the only different is that the optimization method 105 has two output parameter. An optimization method 105 described in record 394 obtains second information 102 from external data server 150 (a web service). In this case, the optimization method 105 first checks the weather of NYC and then modifies related ad campaign based on this external data. The optimization method 105 is particularly useful for company which sells winter equipment. They can set their ad campaign automatically based on weather. If the weather is going to drop new week, and have heavy snow, their ad campaign will be optimized automatically to have a flexible and efficient promotion.

An optimization method 105 described in record 396 takes in external data from two different external servers through two channels. The parameter listed in the compulsory second information 102 is extracted from an email send from an external email server. And the parameter listed in the optional second information field 370 maps to an XML web services. In the record, the optimization unit compares the data from both external data servers and optimizes related ad campaign. In general, optimization method DB 275 maps date sources to optimization method 105 for use by optimization unit 103.

Now referring to record 397, the optimization method 105 described extract data (the item that has the most supply from an auction site), and adjust the ad campaigns from the advertiser and put more weights onto ad campaigns related to the item.

The exemplary records and optimization methods 105 described in FIG. 3 in no way delimit the scope of the use of optimization method DB 275. In one embodiment, optimization method DB is a data mapping diagram that maps data between databases within the ad network server 200, external data servers 150, publisher server 130, and advertiser server 120.

In one embodiment, optimization method DB 275 is configured as part of optimization unit 103; especially in the case that there is only one optimization method 105 in the advertisement delivery network 100. For example, ad network server 200 has only one complicated optimization method 105, there is no reason to have an extra DB to store the information. The optimization unit 103 handles all the information mappings and collections within its functions, code (OS and software instructions 210 etc.).

Referring now to FIG. 4, there is illustrated a functional block diagram depicting the various functional and processing units performed by the optimization unit 103 in accordance with memory 205 and 215, and OS and software instructions 210. The Optimization unit 103 resides in OS and software instruction 210 of the ad server network 200. As shown in FIG. 4, the optimization unit 103 preferably includes a Optimization unit Engine 410, First information Collector 420 that collects first information 101 from data storage system 250, second information collector (internal) 430 that collects information in group 105 within ad server network, second information 102 collector (external) 440 that collects information 102 that belongs to group 106 from external data servers 150, an Optimization method Handler 450 that retrieves the optimization instruction logic, and data mapping information for optimization unit engine 410, and a optimizer decision handler 460 that stores optimizer decisions 104 generated by the optimization unit engine 410 to the data storage system 250. Although Optimization unit 103 is preferably run once for each ad campaign optimization, however it may be run recursively for complex optimization methods 105.

Optimization unit engine 410 preferably is a software function that accepts data collected by first information collector 420, second information collector (internal) 430, and second information collector (external) 440 as input parameters. Optimization unit engine 410 also gets optimization method information about the optimization method 105 from Optimization method Handler 450. Optimization unit engine 410 performs optimizations according to input parameters, optimization method 105. After the optimization, optimization unit engine 410 outputs the optimizer decision 104 and passes it to the optimizer decision handler 460.

First information Collector 420 handles all the first information 101 collection that is required for a valid optimization. First information collector 420 accepts requests from optimization unit engine 410 regarding first information requirements, then collects data from the data storage system 250 according to the requirements. First information collector 420 also validates the data to check if all the compulsory first information data are available. Compulsory first information data preferably includes all the information listed in field 340 of the associated optimization records. First information collector 420 sends validated data back to optimization unit engine 410.

In the preferred embodiment, first information collector 420 collects only first information, which is static data that can be captured internally in data storage system 250 at ad network server 110. Example of static internal data including a date reference which an advertiser wants to change the advertisement rate after it, a new advertisement rate that an advertiser is willing to pay after certain conditions, and maximum spending per month of an advertiser. First information collector 420 may also configured to extract static data from external server the same way second information collector (external) 440 does. The collection process may be as simple as a simple SQL select statement.

Second information collector (internal) 430 performs very similar functions as first information collector 420. However, second information collector (internal) 430 captures only internal dynamic information. Second information collector (internal) 430 accepts requests from optimization unit engine 410 regarding second information requirements, filter out requirements that needs external data, then collects data within ad network server 200 according to the requirement. The collection process may be as simple as a simple SQL select statement.

Second information collector (internal) 430 only captures and collects data belong to group 105 of information 102. Second information collector (internal) 430 also validates the data to check if all the compulsory second information data are available. Second information data preferably includes all the information, which can be captures internal at ad network server, listed in field 360-370 of the associated optimization records. Second information collector (internal) 430 may place the data into second information DB 260 before they are validated, or sent to engine 410. Second information collector 430 sends validated data back to optimization unit engine 410.

In the preferred embodiment, second information collector (internal) 430 collects only second internal information (group 105), which is dynamic data that are modified automatically within ad network server 200. Example of second information that can be captured internally at ad network server 110 including the number of impression viewed in the last week, the click through rate of an ad, system time, and number of expression available to be viewed. These data tends to be updated and modified by ad network server or other software within the server 200, some tends to change very frequently. In one embodiment, second information collector (internal) 430 is configured as part of first information collector 420.

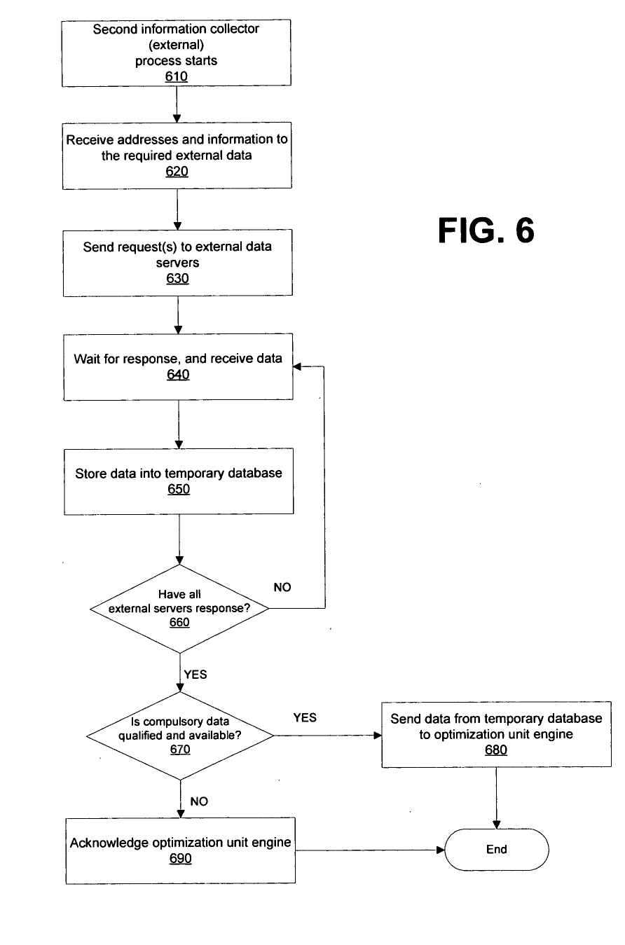

Second information collector (external) 440 collects only second information (group 106) that can only be retrieved externally through external data servers 150. Second information collector (external) 440 captures data from external server and temporary place (second information DB 260) in data storage system 250. After all the compulsory second external information is captured and validated, second information collector (external) 440 sends the data to optimization unit engine 410. An error message indicating the error is sent to engine 410 if any second compulsory external information is missing. Second information collector (external) 440 also validates the data. Detail of an exemplary collector 440 process will be described in FIG. 6.

In the preferred embodiment, second information collector (external) 440 collects only second external information (group 106), which is dynamic data that located externally to ad network server 200. Example of second information that may not be captured within ad network server 200 including the temperature of a city, the number of concert tickets left for an opera, number of PDA model 1234 has been sold at branch 123 of an electronic merchandise company, online marketing budget of a company, or the most overstocked item from a store.

In another embodiment, first information collector 420, second information collector (internal) 430, second information collector (external) are configured as one single collector to collect all static compulsory first information (101), static optional first information (101), static compulsory second information (106), dynamic compulsory second information (105 and 106), static optional second information (106), and dynamic optional second information (105 and 106).

Optimization method Handler 450 handles all the optimization related method and provide optimization unit engine 410 the necessary information that are required to perform a valid optimization. Optimization method Handler 450 retrieves optimization method 105 information including parameters requirements, optimization method 105 instructions 459, and output parameters requirement from data storage system 250, and sends to optimization unit engine 410. Optimization method Handler 450 may download executable optimization method software module from addresses and pass it to decision engine 410. In one embodiment, Optimization method Handler 450 is configured as part of decision engine 410.

Optimization method representation 451 may be in various forms, including but not limited to: human reading forms 452 (the same form shown in FIG. 3), binary files 453 reside in DB 275, address 454 of files, and object files 455.

Optimization method representations 451 may also be addresses 452 to software functions (executable files, web services) from local storage or external sources. Examples are “http://abc.com/optimizer123.exe”, “ftp://abc@efgh.com:382”, and “http://123.com/webservice.asm×”.

Optimization method representations 451 may be binary files 453 stored directly in Optimization method DB 275. Software functions are stored physical in DB 270 along with other information. For example, a data type of varbinary in MS SQL 2000 database may be used as the data type of field 330. The varbinary data type of MS SQL can be used to store a variable-length binary data with a maximum length of 8000 bytes.

Optimization method representations 451 may be handled as parameters 452 and accepted by optimization units the same way optimization unit 103 accepts information 340-370. For example, optimization unit is run in a way such as:
execute optimization_unit_function(var instructiontype);
   where the parameter is the data from the field 330.

Yet another embodiment, Optimization method representations 451 are compiled as an object files 455 which is not a standalone executable program, which can be also passed in to the optimization unit as well. Exemplary values for this embodiment are (“optimizer.obj”, “optimizer2.bin”).

The object of provide a system and method for adapting different types of optimization methods 105 and software architecture is achieved here.

Optimizer decision handler 460 sends optimizer decision 104 generated by decision engine 410 and stores them to the data storage system 250. In the preferred embodiment, the decisions are stored to the optimization decision DB 270 for later use.

There are many ways of using the data in optimization decision DB, one way is that a database procedure is triggered when an insert action is executed against optimization decision DB 270 and the procedure updates the ad network server 110 to reflect the changes. Or, the decision has to be approved by related human being, ad network server administrator, or system before performing further action to the ad network server 110. The object of providing a system and method for automatic and manual optimization is achieved here. Optimizer decisions may be an update or modify request on certain data in the ad campaign database, or it can be an error message.

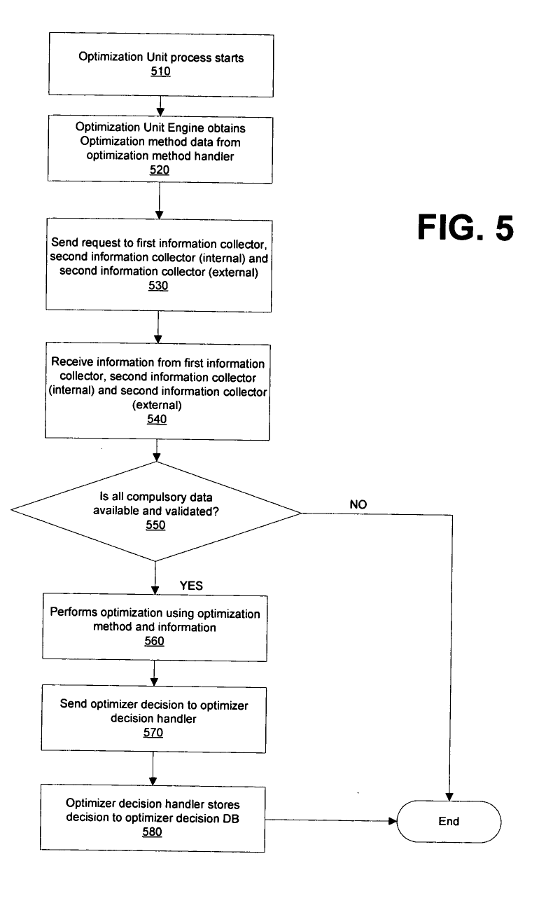

FIG. 5 illustrates the steps that optimization unit 103 preferably performs. Optimization unit processes starts at step 510. At step 520, optimization unit engine 410 sends request to Optimization method Handler 450 with information (optimization method 105 ID etc) related to the optimization method 105 that is needed. Optimization method handlers 450 retrieve the information from optimization method DB 275 in data storage system 250. Optimization handler 450 then sends the instructions information, input and output parameters back to the optimization unit engine 410. After receiving the optimization data from optimization method handler, decision engine 410 analyzes the data.

At step 530, optimization unit engine 410 sends one or more parameter requests 107 to first information collector 420, second information collector (internal) 430, and second information collector (external) 440. The requests preferably include lists of compulsory and optional parameters for the current optimization method 105. The parameter requests 107 maybe very specific data such as, “I need the number of TV sold last week”, or “I need the temperature forecast in Celsius for next Monday”. The parameter requests 107 may be very general requests such as “I want number of each product sold last week by product ID”, or “I need all the day time temperature forecast for all next week in Celsius”.

At step 540, information is received back from the collectors; the information sent back are either validated parameters with useful information or error messages indicating that some compulsory information is missing.

At step 550, optimization unit engine 410 analyzes the responses from the collectors, if there is any error message sent from collectors 420-440, it means some of the data is invalid or available. Available and valid compulsory information means that all the compulsory first and second information are available and they are qualified to be passed in as input parameters for the current optimization method 105. If any of compulsory information is invalid or unavailable, engine 410 notifies optimizer decision handler about the errors. Then optimizer decision handler 450 logs the error to ad network server. If all compulsory data are available and valid, the optimization unit process continues to step 560.

At step 560, after all information is good and ready to use, optimization unit engine 410 performs the optimization. Optimization unit engine 410 runs the instructions passed in by Optimization method handler 450 and use information received in step 540 as input parameter. Optimization unit engine 410 may compile the information sent by optimization method 105 into executable files and run it using information received in step 540, or optimization unit engine compile the instruction along with the parameters. In other embodiment, optimization unit engine 410 downloads optimization related files from external sources based on the addresses and information sent by Optimization method Handler 450 at step 520.

After the optimization is finished, at step 570, optimization unit engine 410 acknowledges optimizer decision handler 460 and passes the optimizer decisions 104 to the handler. At step 580, optimizer decision handler 460 stores the optimizer decisions 104 into data storage system 250 for further use. The decisions 104 are preferably stored in optimization decision DB 270. The optimizer decisions 104 may be used to update the databases immediately, or have to wait for further approval procedure.

After the optimizer decision handler 470 finishes storing the information, the optimization unit process ends.

FIG. 6 illustrates a flow chart that shows the steps of the second information collector (external) 440 process. The collector 440 process only collect group 106 data of information 102. The second information collector (external) process starts when decision engine 410 sends a parameter request to the second information collector (external) 440 at step 610. At step 620, second information collector (external) 440 receives requirements of necessary data. The data may include addresses of the external sources, external sources type, password and username to access external data server, and other information.

External sources type is used by the second information collector (external) to classify the type of external sources it is. Example values of external sources type including “WEB SERVICE”, “EMAIL”, “ORACLE DB”, “XML”, “TEXT FILE”, “SMS”, “ICQ”, “FTP” etc.

After receiving the information, second information collector (external) process continues. At step 630, second information collector (external) process starts sending out request to external data servers. The requests maybe in many different forms depend on the external source types. It may be invoking a web services through HTTP protocol, checking an email account for a specific receiver, using the FTP's GET command to download a file, an OLEDB connect function that retrieve data from an external database using SQL statement, or sending a formatted SMS message to a particular SMS number.

After sending out all the requests, the process idle at step 640 until responses received. Additional information maybe needed to submit to external data servers 150 if necessary. Therefore, step 630 and 640 repeats until the data is arrived correctly, or a termination of communication. It happens when some external data server require a more than one levels of security, or when data are lost while transferring.

If the data are received, at step 650, second information collector (external) 440 stores the data to the second information DB 260 in the correct and understandable (by optimization unit engine) format. If the process fails to request certain data and receive error message from external data servers, the process will also log the error into the second information DB 260. The information is used by step 550 when checking for data qualification. At step 660, second information collector (process) checks if all requests have been responded. If all data requests have been responded, the process continues to step 670. If not all data requests have been responded, the process will go back to step 640 and wait. The second information collector (external) process can be set to stop waiting (exit step 640 and continue to step 670) after a predetermined time limit, in case any of the external data server 150 is down and do not reply at all.

At step 670, the second information collector (external) process validate the data in the second information DB 260 and check if they are qualified. For example, if the number of TV sold from a company is requested, the return data is 9999, which is a dummy value of the external database return for SQL query that returns no value. Therefore, step 670 is responsible to check the data and make sure they qualified before they are sent to optimization unit engine 410. If the parameter requests 107 are a general requests (requests that are not specifying any particular data), step 670 also filters out unnecessary data.

The object of providing a system and method for accessing different type of external data, and external data management to ensure data qualification is achieved here.

If all the compulsory data are qualifying and ready to be use, second information collector (external) then sends all the data to optimization unit engine and acknowledge it that the data are good to use. Other action such as cleaning the second information DB 260 may be performed in this step as well.

If any of the compulsory data is failing the validation, at step 690, second information collector (external) then acknowledges optimization unit engine 410 that not all compulsory second information are available. The process may be modified to repeat step 630 for particular failing data, in order to check if it still returns failing data.

The steps performed in FIG. 6 maybe processed one or more time as necessary according to the complexity of the optimization method 105. Some optimization method may require information collectors 420-440 to collect data more than once during the optimization process described in FIG. 5.

### Cryptographic Authentication Embodiment

In the previous embodiments, data requests and data are sent between ad network server and external data server using no authentication or method as simple as password and usernames. Although this procedure works well in a low security environment, it can be significantly improved through the use of cryptographic protocols. These protocols not only enhance the ability to authenticate the sender of a message, but also serve to verify the integrity of the message itself, proving that it has not been altered during transmission. Such techniques shall be referred to generally as cryptographic assurance methods, and will include the use of both symmetric and asymmetric keys as well as digital signatures and hash algorithms.

The practice of using cryptographic protocols to ensure the authenticity of users as well as the integrity of messages is well known in the art and need not be described here in detail. For reference, one of ordinary skill in the art may refer to Bruce Schneier, Applied Cryptography, Protocols, Algorithms, And Source Code In C, (2d Ed, John Wiley & Sons, Inc., 1996).

### CONCLUSION, RAMIFICATIONS, AND SCOPE OF INVENTION

Thus the reader will see that the method and system of the invention provides an efficient, intelligent, cost saving, yet powerful method that can be used by advertisers to optimize their ad campaign using external data that are not directly related to their advertisements. With the present invention, advertisement can closely execute their business and marketing plan with advertisement. The present invention can help advertiser to save human cost, and yet enhance their marketing results.

Those skilled in the art will recognize that the method and apparatus of the present invention has many applications and that the present invention is not limited to the representative examples disclosed herein. Moreover, the scope of the present invention covers conventionally known variations and modifications to the system components described herein, as would be known by those skilled in the art.

1. A system for optimizing one or more advertisement campaigns for an advertiser, said system comprising:
a) means for obtaining second information not relating to said advertisement campaigns according to an advertisement network server during a period of time whereby said advertisers can use irrelevant data to optimize said advertisement campaigns if said advertisers want;
b) processing means for receiving said obtained second information, collecting said obtained second information relating to advertisement campaigns according to one or more optimization methods, and validating said collected second information according to said optimization methods;
c) means for obtaining one or more optimizer decisions related to said one or more advertisement campaigns according to said one or more optimization methods;
d) and, means for updating one or more storage means for storing said optimizer decisions.

2. The system as claimed in claim 1, wherein said means for obtaining said second information includes: means for retrieving said second information from said advertisement network server, and means communicable with said advertisement network server for receiving said second information from one or more external data servers physically located away from said advertisement network server whereby advertiser can use data originated externally to optimize said advertisement campaigns.

3. The system as claimed in claim 2, further including means for obtaining first information including data relating to said one or more advertisement campaigns according to said advertisement network server.

4. The system as claimed in claim 2, wherein said one or more external data servers includes one or more of: web service servers, database servers, file transfer protocol servers, extensible markup language file locations, text file locations, and email servers.

5. The system as claimed in claim 2, further including: one or more advertiser servers, and one or more publisher servers.

6. The system as claimed in claim 5, said advertiser server is said advertisement network server.

7. The system according to claim 5, wherein said one or more publishers equipped with one or more communication devices, said one or more communication devices include one or more of: web site banner spaces, electronic billboard displays, televisions and monitors or digital display devices, speaker systems, large screen displays, projection and movie screens, and printers.

8. The system according to claim 3, wherein said means for obtaining said one or more optimizer decisions relating to said one or more advertisement campaigns according to said one or more optimization methods includes: means for accepting said second information, and said first information as parameters; means for generating said one or more optimizer decisions considering said parameters according to said one or more optimization methods; means for outputting said one or more optimizer decisions to said advertisement network server.

9. The system as claimed in claim 2, further including database memory including data relating to: said advertiser data including data relating to a plurality of advertisement campaigns, said publisher data including data relating to said one or more communication device, said optimizer decisions relating to said optimization methods, and said optimization methods.

10. The system as claimed in claim 5, wherein said second information and said first information further including data relating to business operations of said one or more advertiser server, said one or more publisher servers, said advertisement network server, and said one or more external data servers.

11. The system as claimed in claim 2, where said optimization method 105 represented in one or more forms, said one or more forms include: human readable forms, binary files reside in said storage means, address of files, and object files.

12. A method for optimizing one or more advertisement campaigns for an advertiser, said method comprising the steps of:
a) obtaining second information not relating to said advertisement campaigns according to an advertisement network server during a period of time whereby said advertisers can use irrelevant data to optimize said advertisement campaigns if said advertisers want;
b) collecting said obtained second information relating to said advertisement campaigns according to one or more optimization methods;
c) validating said collected second information according to said one or more optimization methods;
d) generating one or more optimizer decisions related to said one or more advertisement campaigns according to said one or more optimization methods;
e) and, updating one or more storage means for storing said optimizer decisions.

13. The method as claimed in claim 12, wherein said second information includes: data retrieving from advertisement network server, and data receiving from one or more external data servers physically located away from said advertisement network server whereby advertiser can use data originated externally to optimize said advertisement campaigns.

14. The method as claimed in claim 13, wherein said step of obtaining second information further comprising the steps of:
a) communicating with one or more external data servers physically located away from the said advertisement network server;
b) sending data requests relating to said one or more advertisement campaigns according to said one or more optimization methods to said one or more external data server;
c) receiving data relating to said one or more advertisement campaigns according to said one or more optimization methods from said one or more external data server.

15. The method as claimed in claim 13, further including steps of obtaining first information including data relating to said one or more advertisement campaigns according to said advertisement network server.

16. The method as claimed in claim 13, wherein said one or more external data servers includes one or more of: web service servers, database servers, file transfer protocol servers, extensible markup language file locations, text file locations, and email servers.

17. The method as claimed in claim 13, further including: one or more advertiser servers, and one or more publisher servers.

18. The method as claimed in claim 17, said advertiser server is said advertisement network server.

19. The method according to claim 17, wherein said one or more publishers equipped with one or more communication devices, said one or more communication devices include one of: web site banner spaces, electronic billboard displays, televisions and monitors or digital display devices, speaker systems, large screen displays, projection and movie screens, and printers.

20. The method according to claim 15, wherein steps of obtaining an optimizer decision related to said one or more advertisement campaigns according to said one or more optimization methods includes:
a) accepting said second information, and said first information as parameters;
b) obtaining said one or more optimizer decisions considering said parameters according to said one or more optimization methods;
c) outputting said one or more optimizer decisions to said advertisement network server.

21. The method as claimed in claim 13, further including steps of storing data relating to:
said advertiser data including data relating to a plurality of advertisement campaigns, said publisher data including data relating to said one or more communication device, said optimizer decisions relating to said optimization methods, and said optimization methods.

22. The method as claimed in claim 13, wherein said second information and said first information further including data relating to business operations of said one or more advertiser server, said one or more publisher servers, said advertisement network server, and said one or more external data servers.

23. The method as claimed in claim 13, where said optimization method represented in one or more forms, said one or more forms include: human reading forms, binary files reside in said data storage, address of files, and object files.
